(19) United States
(12) Patent Application Publication
(10) Pub. No.: US 2008/0061052 A1
(43) Pub. Date: Mar. 13, 2008

(54) Device for delivery of heat

(75) Inventors: Martina Roettinger, Muenchen (DE); Andreas Haertl, Muenchen (DE); Wolfgang Heinz-Weger, Tuerkenfeld (DE)

Correspondence Address: DOBRUSIN & THENNISCH PC, 29 W LAWRENCE ST, SUITE 210, PONTIAC, MI, 48342, US

(73) Assignee: W.E.T. AUTOMOTIVE SYSTEMS AG

(21) Appl. No.: 11/899,800

(22) Filed: Sep. 7, 2007

(30) Foreign Application Priority Data
Sep. 12, 2006 (DE) 102006043525.7

(51) Int. Cl. H05B 1/02; H05B 1/00

(52) U.S. Cl. 219/494; 219/217

(57) ABSTRACT

The present invention relates to a device for delivering heat comprising at least one heat reservoir, and at least one electrical heating element for heating the at least one heat reservoir, wherein at least one of the at least one heat reservoir is a latent heat reservoir.

### CLAIM OF PRIORITY

The present application claims the benefit of the filing date of German Application Nos. DE 102006043525.7 (filed Sep. 12, 2006) the contents of which are hereby incorporated by reference in their entirety.

### FIELD OF THE INVENTION

The present invention relates to a device for delivering heat in accordance with the preamble of the independent claims. Generic devices are, for example, used as heat storage cushions for seat pads.

### BACKGROUND OF THE INVENTION

From AT 006607 U1 a beverage container is known that can be kept warm using a latent heat reservoir. It is suggested that the latent heat reservoir be heated e.g. in a water bath until such time as the salt solution in the heat reservoir has liquefied. Such a method is cumbersome and not very efficient because very large quantities of heat are wasted in heating up the water bath.

From AT 004722 U2 and AT 004756 U2 it is known to provide heating blankets for animals containing pockets for insertion of heat cushions, for example filled with sodium acetate-trihydrate as a heat reservoir. In both, there is no reference to an appropriate heat input into the heat reservoir. Thus it has to be assumed that a water bath is also used in this instance.

From DE 20308440 and DE 1922114 cushions are known in which an electrical heating element is additionally provided with glass fibre mats or gel packs for intermediate storage of heat. These devices have the disadvantage that they do not permit activation of heating in the absence of electrical power. They simply allow the heating time to be extended subsequent to the power being switched off and achieve a more uniform heat distribution.

It is therefore desirable to provide a device that delivers heat at any optionally chosen point in time independently of an electrical connection and is easier to operate than the known state of the art

### SUMMARY OF THE INVENTION

As an addition to the state of the art, a device in accordance with claim 1 is proposed.

Such a device for delivering heat has, together with the advantages associated with the state of the art, also the advantage that it does not contain heavy, solid components such as for example batteries. This complies with safety requirements in sport arenas.

Additional advantageous embodiments are set out in the following description and in the dependant claims

### BRIEF DESCRIPTION OF THE INVENTION

Details of the invention are discussed below. These descriptions are meant to make the invention understandable. However, they serve as examples only. As a matter of course, individual or several of the features described can also be omitted, altered or augmented. Further, the features of different embodiments can naturally be combined one with another. In the following, reference is made to:

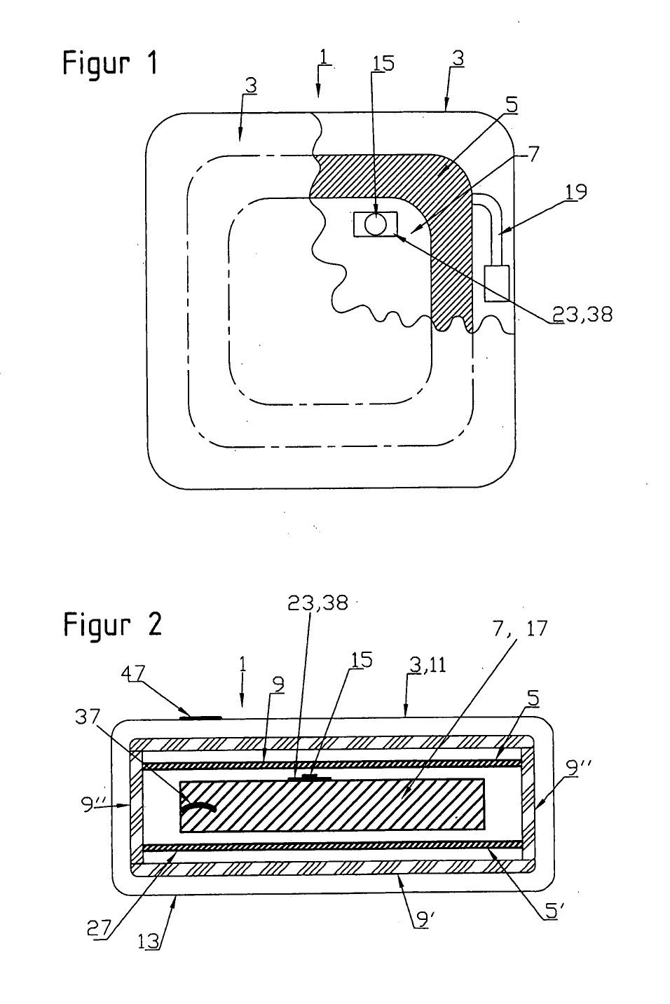

FIG. 1, which is a top view, partly in section, of a device for delivering heat.

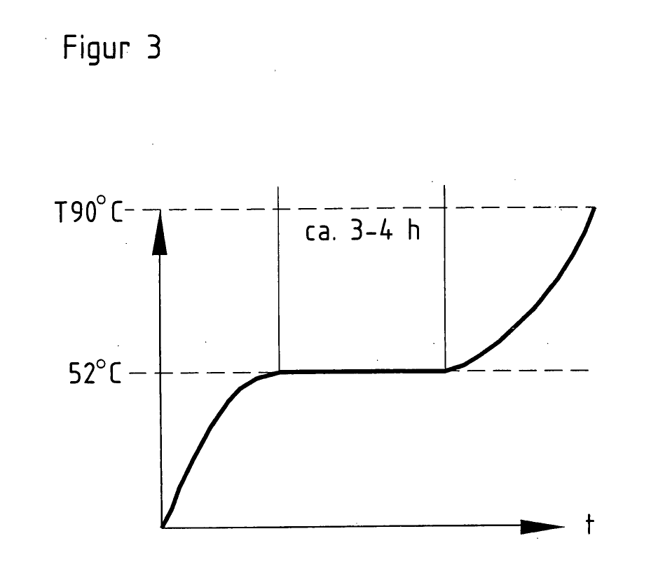

FIG. 2, which is a longitudinal section through the embodiment of FIG. 1.

FIG. 3, which shows a temperature curve when charging the device with thermal energy.

### DETAILED DESCRIPTION OF THE INVENTION

FIG. 1 shows a device 1 for delivering heat. It is portable and can for example be used for heating hunters in raised hides, stall sellers in open-air markets, or spectators at sports events. All components of device 1 are preferentially at least in part made of flame retardant materials. They can, at least in part, preferentially also contain foaming agents to isolate, in case of local overheating, such an overheated area from its surroundings.

The device 1 incorporates a heat reservoir 7. This is preferably flat, flexible and, in the embodiment, substantially rectangular. It can, however, be suitably adapted in terms of its geometry to suit any given application and can e.g. be in the form of a company logo or an animal motive or it can be moulded to the shape of a baby seat or of a pram.

The heat reservoir 7 is preferentially equipped with a storage medium 17 which stores heat as latent heat. Salt solutions such as sodium acetate-trihydrate or paraffins are e.g. suitable for this purpose. The temperature arising upon release of the stored latent heat is preferentially in the range of 40 to 70° C., in the embodiment described it is about 58° C.

The heat storage medium 17 is enclosed in a jacket 27. Materials such as for example polyurethane, PVC, rubber or other polymer materials are conceivable for this application. The film is able to withstand a temperature of preferentially at least 100° C., preferentially more than 150° C.

The heat reservoir 7 is fitted with a trigger mechanism 37 which, when activated, can release heat stored latent in heat reservoir 7 at any chosen point in time. In the embodiment described here, this consists of a metal strip, bending of which gives rise to crystallisation and thus to a release of heat in the heat storage medium 17. The trigger mechanism is preferentially located away from electrical heating conductors in order to avoid damage to the heating element. The trigger mechanism 37 is preferentially provided with a marking 47 on the cover 3 of the device 1, in order to allow ease of triggering even when the cover is closed.

The trigger mechanism 37 is preferentially shielded at least partly from its surroundings by an intermediate layer 9, 9′, 9″ of padding material so as to avoid unintentional triggering.

The device 1 is provided in addition with at least one electrical heating element 5, 5′ in order to heat the heat reservoir 7. This heating element 5, 5′ is expediently located in the heat storage medium 17, in the jacket 27 and/or in the vicinity of the heat reservoir 7. In the present embodiment, the heat reservoir 7 is covered with an electrical heating element 5, 5′ on the top side 11 facing a user and on the bottom side 13 facing away from a user. Heating the heat reservoir on both sides leads to rapid heat soaking of the heat storage medium 17 as the heat storage medium is a poor heat conductor due to its high heat storage capability such that heat soaking would otherwise take very long even though this would be fundamentally conceivable.

The heating element 5, 5′ can be designed in one piece or in the form of two heating elements. The heating elements 5, 5′ proposed here project over the edges of the heat reservoir 7 to also assure thorough heat soaking of its peripheral areas. Otherwise, residual crystals could continue to be present which then would act as crystallisation nuclei and cause heat release immediately after charging the heat reservoir. The heating elements 5, 5′ can be connected to an external power source via a connector plug 19. This power source can for example be a transformer or a power socket.

The heating element 5, 5′ can for example be provided with a textile carrier on which a heating wire, a wire braiding or carbon fibres are distributed over the face. The heating conductors can be electrically insulated or non-insulated. The heating element can also be provided with electrically conductive plastic fibres or electrically conductive coated plastic fibres. It can be in the form of a continuous wavy layer single conductor or a multiplicity of heating conductors connected in parallel via electrodes.

The heat reservoir 7 and the heating elements 5, 5′ are preferably provided with at least one intermediate layer 9, 9′, 9″. This provides cushioning and a more uniform pressure distribution when subjected to compression by a user. Furthermore, it allows for uniform heat release for the user. Furthermore, it limits the temperatures arising on the external face of the cover 3 in order to prevent the user suffering burns from the heat reservoir 7 or the heating element 5, 5′. Furthermore, it reduces heat dissipation from the heating element 5, 5′ to the surroundings during the reservoir charging process. Preferentially, the distribution layer 9′ is thicker and/or lower in heat conductance on the back of the device 1 than on its top side. Heat dissipation to the ground is thus reduced when the device 1 is in use. The intermediate layer 9 on the top side of the device 1 is preferentially made at least in part of a material which changes its thermal conductivity depending on pressure load, e.g. insulating polymer foam. Preferentially, thermal conductivity goes up as pressure load increases, i.e. when the device 1 is sat upon by a user. When not occupied, i.e. with reduced pressure load, thermal conductivity is preferentially reduced. In order to compensate for a lesser degree of insulation, the heating element 5 on the top side 11 of the device 1 can receive more heat input or the heating element can be designed with a higher area output.

All components referred to are preferentially contained in a casing 13. The casing 13 is preferentially water-repellent or waterproof. On the rear side of the device 1, it can be made to be non-slip, in particular coated or knobbed. The bottom part of the cover 3 can be glass fibre reinforced. Preferentially, the cover has a resealable opening on the side, for example in the form of a zipper. A plug connector 19 of the heating element 5, 5′ can be taken out through this opening for the charging process. During transport and use of the device 1, it can subsequently be stowed again inside the cover.

When the heat reservoir 7 is empty, it can be provided with thermal energy by connecting the heating elements 5, 5′ to an electrical power source. In this process, the temperature is measured by a temperature sensor 15 in the vicinity of the heat reservoir 7. This temperature sensor 15 is assigned to a thermostat 23 or formed by same.

When the heating element 5, 5′ is connected to electrical power, the temperature in the heat reservoir initially rises approximately linearly and then levels off in a plateau phase for an extended period of time as shown in FIG. 3. During this time, latent heat is stored in the heat reservoir 7 as a result of a phase change of the heat storage medium 17. In the embodiment described, this plateau is at 58° C. and continues for about three to four hours as a function of the available heating input. During this phase, the temperature of the heating element 5, 5′ lines out such that temperatures in the range of about 50 to 70° C. arise at the heat reservoir 7. When the heat reservoir is fully charged i.e. when the phase change has been fully achieved, the temperature prevailing at the heat reservoir 7 rises again significantly. In the embodiment discussed, power supply to the heating elements 5, 5′ is interrupted at a temperature of about 90° C. The heating elements 5, 5′ and the heating reservoir 7 subsequently cool down and reach ambient temperature at some point in time.

During this cooling process, the thermostat 23 would indeed switch on the heating elements 5, 5′ again at some point in time and trigger another heating-up process following the dashed line. But this is undesirable because the device 1 would unnecessarily waste electrical energy and be subjected to unnecessary thermal stressing. In order to prevent the thermostat 23 from switching on the heating current, thermostat 23 is fitted with an integrated heating element 38, preferably a PTC element. This is switched on when the thermostat 23 is switched off. The additional heating element 38 supplies heat until the device 1 is disconnected from the power supply. In this way, the heating element 38 simulates a higher temperature reading at the heat reservoir 7 for the thermostat 23 than that actually prevailing. This prevents the heating current from being switched on again.

The device 1 can be foldable or collapsible into two or more sections so that it can be used to simultaneously heat a seat and a seat backrest. For that purpose, the heat reservoir 7 can be flexed. It is also possible to provide two or more separate heat reservoirs, the folded sections being provided each with a separate heat reservoir. The same applies for the heating elements 5, 5′.

If the device 1 is designed with several heat reservoirs, these are preferentially charged automatically in sequence. In this instance, the device 1 is preferentially equipped with an internal switchover unit. With adequate heating capacity, it is also possible to charge several heat reservoirs simultaneously.

It can be seen that the invention can also be described with reference to the following combinations.

A. A device (1) for delivering heat, with at least one heat reservoir (7) and at least one electrical heating element (5, 5′) for heating the heat reservoir (7), characterised in that the heat reservoir (7) is a latent heat reservoir.

B. A device according to combination A, characterised in that the release of heat stored in a fully charged heat reservoir (7) is dependant on an activation event being triggered.

C. A device according to any of the preceding combinations A or B, characterised in that the device is fitted with at least one thermostat (25) for monitoring the temperature of the heat reservoir (7), said thermostat shutting off an electrical heating current when a minimum temperature is reached, and that the thermostat (25) is assigned its own heating element (38) in order to prevent the thermostat (25) switching on the heating current again by supplying heat to the thermostat (25), after the device (1) has cooled down.

D. A device according to any of the preceding combinations A through C, characterised in that the heat reservoir (7) is at least in part provided with an intermediate layer (9) in order to distribute ambient pressure acting locally on the heat reservoir or disseminate heat flows emanating from the heat reservoir onto a larger surface area or achieve at least partial thermal isolation between the cover (3) and the heat reservoir (7).

E. A device according to any of the preceding combinations A through D, characterised in that at least one connector plug (19) of at least one heating element (5, 5′) can be taken out of the cover for charging and can be subsequently reinserted into the cover (3) of the device (1), preferentially that the connector plug (19) is accessible from outside without opening the cover (3), without substantially protruding beyond the outline of the device.

F. A device according to any of the preceding combinations A through E, characterised in that at least one electrical heating element (5, 5′) is arranged on the jacket (27) and/or in the heat storage medium (17) of the heat reservoir (7).

### REFERENCE NUMBERS

1 Device for delivering heat
2 Cover
5, 5′ Heating element
7 Heat reservoir
9, 9′, 9″ Intermediate layer
11 Top side of pad
13 Rear side of pad
15 Temperature sensor

1. A device for delivering heat comprising at least one heat reservoir, and at least one electrical heating element for heating the at least one heat reservoir, wherein at least one of the at least one heat reservoir is a latent heat reservoir.

2. The device of claim 1, wherein the release of heat stored in a fully charged heat reservoir is dependant on an activation event being triggered.

3. The device of claim 1, further comprising at least one thermostat for monitoring the temperature of the at least one heat reservoir, wherein the thermostat is configured to shut off an electrical heating current when a minimum temperature is reached and wherein the thermostat includes a first heating element, which prevents the thermostat from reactivating the heating current once the device has cooled down.

4. The device of claim 2, further comprising at least one thermostat for monitoring the temperature of the at least one heat reservoir, wherein the thermostat is configured to shut off an electrical heating current when a minimum temperature is reached and wherein the thermostat includes a first heating element, which prevents the thermostat from reactivating the heating current once the device has cooled down.

5. The device of claim 1, wherein the at least one heat reservoir is at least partially disposed within an intermediate layer so as to distribute ambient pressure acting locally on the at least one heat reservoir, to disseminate heat flow emanating from the at least one heat reservoir onto a larger surface area, to achieve at least partial thermal isolation between a cover and the at least one heat reservoir, or combinations thereof.

6. The device of claim 2, wherein the at least one heat reservoir is at least partially disposed within an intermediate layer so as to distribute ambient pressure acting locally on the at least one heat reservoir, to disseminate heat flow emanating from the at least one heat reservoir onto a larger surface area, to achieve at least partial thermal isolation between a cover and the at least one heat reservoir, or combinations thereof.

7. The device of claim 3, wherein the at least one heat reservoir is at least partially disposed within an intermediate layer so as to distribute ambient pressure acting locally on the at least one heat reservoir, to disseminate heat flow emanating from the at least one heat reservoir onto a larger surface area, to achieve at least partial thermal isolation between a cover and the at least one heat reservoir, or combinations thereof.

8. The device of claim 4, wherein the at least one heat reservoir is at least partially disposed within an intermediate layer so as to distribute ambient pressure acting locally on the at least one heat reservoir, to disseminate heat flow emanating from the at least one heat reservoir onto a larger surface area, to achieve at least partial thermal isolation between a cover and the at least one heat reservoir, or combinations thereof

9. The device of claim 1, wherein the at least one heating element includes at least one connector plug that can be taken out of the cover for charging and can be subsequently reinserted into the cover of the device, the connector plug being accessible from outside without opening the cover, without substantially protruding beyond the outline of the device.

10. The device of claim 2, wherein the at least one heating element includes at least one connector plug that can be taken out of the cover for charging and can be subsequently reinserted into the cover of the device, the connector plug being accessible from outside without opening the cover, without substantially protruding beyond the outline of the device.

11. The device of claim 3, wherein the at least one heating element includes at least one connector plug that can be taken out of the cover for charging and can be subsequently reinserted into the cover of the device, the connector plug being accessible from outside without opening the cover, without substantially protruding beyond the outline of the device.

12. The device of claim 5, wherein the at least one heating element includes at least one connector plug that can be taken out of the cover for charging and can be subsequently reinserted into the cover of the device, the connector plug being accessible from outside without opening the cover, without substantially protruding beyond the outline of the device.

13. The device of claim 8, wherein the at least one heating element includes at least one connector plug that can be taken out of the cover for charging and can be subsequently reinserted into the cover of the device, the connector plug being accessible from outside without opening the cover, without substantially protruding beyond the outline of the device.

14. The device of claim 1, wherein the at least one electrical heating element is disposed about a jacket, a heat storage medium, or both.

15. The device of claim 2, wherein the at least one electrical heating element is disposed about a jacket, a heat storage medium, or both.

16. The device of claim 3, wherein the at least one electrical heating element is disposed about a jacket, a heat storage medium, or both.

17. The device of claim 5, wherein the at least one electrical heating element is disposed about a jacket, a heat storage medium, or both.

18. The device of claim 8, wherein the at least one electrical heating element is disposed about a jacket, a heat storage medium, or both.

19. The device of claim 13, wherein the at least one electrical heating element is disposed about a jacket, a heat storage medium, or both.

20. A method for delivering heat comprising the steps of
providing:
at least one heat reservoir at least one heat reservoir is at least partially disposed within an intermediate layer so as to distribute ambient pressure acting locally on the at least one heat reservoir;
at least one electrical heating element having at least one connector plug that can be taken out of the cover for charging and can be subsequently reinserted into the cover of the device, the connector plug being accessible from outside without opening the cover, without substantially protruding beyond the outline of the device; and
at least one thermostat having a first heating element, which prevents the thermostat from reactivating the heating current once the device has cooled down;
heating the at least one heat reservoir with the at least one electrical heating element, wherein at least one of the at least one heat reservoir is a latent heat reservoir;
monitoring the temperature of the at least one heat reservoir, wherein the thermostat is configured to shut off an electrical heating current when a minimum temperature is reached; and
disseminating heat flow emanating from the at least one heat reservoir onto a larger surface area, to achieve at least partial thermal isolation between a cover and the at least one heat reservoir, or combinations thereof,
wherein the at least one electrical heating element is disposed about a jacket, a heat storage medium, or both.
